(19) United States
(12) Patent Application Publication
(10) Pub. No.: US 2005/0160101 A1
(43) Pub. Date: Jul. 21, 2005

(54) Method and apparatus using dynamic SQL for item create, retrieve, update delete operations in a content management application

(75) Inventors: Edward Joseph Gallagher, San Jose, CA (US); Phong Kim Truong, San Jose, CA (US); Fang-Yi Wang, San Jose, CA (US)

Correspondence Address: Min, Hsieh & Hack, L.L.P., Suite 160, 125 University Avenue, Palo Alto, CA, 94301, US

(73) Assignee: INTERNATIONAL BUSINESS MACHINES CORPORATION

(21) Appl. No.: 10/758,090

(22) Filed: Jan. 16, 2004

(51) Int. Cl. G06F 7/00

(52) U.S. Cl. 707/100

(57) ABSTRACT

One feature of the present invention provides a content management system that can handle a wide variety requests by using different types of items with differing attributes. The content management maintains a set of tables to manage the items. A first table is used to index or catalog each of the items and its type. A second table is used to store the attributes of each type of item. The attributes specify information about the item's type and may also include a partial SQL statement. When needed, the content management system may then use these tables to determine an item's type, retrieve the attributes for that type, obtain a partial SQL statement from the attributes, and dynamically build a SQL statement to process a wide variety of requests or commands.

### FIELD

This invention relates generally to managing enterprise content.

### BACKGROUND

Today, many businesses use a content management system to manage their information. For example, a business may use a content management system to organize its documents, files, faxes, etc. Typical content management systems use a database and static structured query language (“SQL”) statements to manipulate the information stored within the system. For example, when a user updates a document, known content management systems will analyze the update and select a pre-generated set of static SQL statements to process the update. If there are relatively few types of updates, then a set of static SQL statements can be easily pre-generated for each scenario.

Unfortunately, content management systems must often accommodate a wide variety of variations in the requests and updates that it processes. For example, a content management system may allow searches of its database by name, address, city, state, ZIP code, or any combination thereof. However, it is impractical to pre-generate sets of static SQL statements for every possible variation or scenario. Indeed, there are times when it is difficult to determine the appropriate SQL commands until the user makes the request or command. Therefore, many known content management systems limit the format that a user may use to make a request or command.

Dynamic SQL allows an SQL statement to be constructed dynamically and may assist in providing some flexibility in handling variable requests from users. However, dynamic SQL is significantly more complicated than static SQL and requires more processing and memory resources from the content management system. As a result, known content management systems often suffer in performance when they use dynamic SQL. Therefore, many known content management systems do not use dynamic SQL.

It would therefore be desirable to provide content management systems that can handle variations in user requests. It may also be desirable to provide content management systems an efficient way to use dynamic SQL.

### SUMMARY

In accordance with one feature of the invention, a structured query language statement is dynamically prepared. A request that affects an item is received. A respective type of the item is identified, and a set of attributes and a portion of a structured query language statement is retrieved based on the type of the item. A structured query language statement is then prepared for the item based on the set of attributes and the portion in response to the request.

In accordance with another feature of the invention, a system that dynamically prepares a structured query language statement is provided. A database stores a plurality of items in a first table and stores information indicating attributes of each type of item in a second table. A processor is configured by a set of program code to receive a request that affects an item stored in the first table of the database, identify a type of the item based on information in the first table, retrieve attributes for the item from the second table based on the item's type, determine a portion of a structured query language statement based on parsing the attributes, and prepare the structured query language statement for the item based on the retrieved attributes and the portion in response to the request.

Additional features of the invention will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 shows a content management system that is consistent with the principles of the present invention;

FIG. 2 shows a conceptual diagram of a library server that is consistent with the principles is invention;

FIG. 2A shows one example of tables that may be used by the library server in accordance with the principles of the present invention;

FIG. 3 shows a conceptual diagram of a resource manager that is consistent with the principles of the present invention; and

FIG. 4 shows a flow diagram for dynamically constructing SQL statements in accordance with the principles of the present invention.

### DESCRIPTION OF THE EMBODIMENTS

One feature of the present invention provides a content management system that can handle a wide variety requests by using different types of items with differing attributes. The content management maintains a set of tables to manage the items. A first table is used to index or catalog each of the items and its type. A second table is used to store the attributes of each type of item. The attributes may specify information, such as input and output parameters, data types, references, and may also include a partial SQL statement. When needed, the content management system may then use these tables to determine an item's type, retrieve the attributes for that type, obtain a partial SQL statement from the attributes, and dynamically build a SQL statement to process a wide variety of requests or commands.

Reference will now be made in detail to exemplary embodiments of the invention, which are illustrated in the accompanying drawings. Wherever possible, the same reference numbers will be used throughout the drawings to refer to the same or like parts.

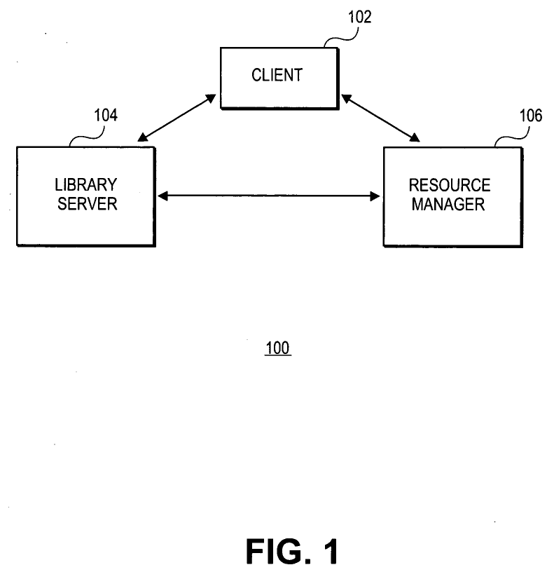

FIG. 1 shows a content management system 100 that is consistent with the principles of the present invention. As shown, content management system 100 may comprise a client 102, a library server 104, and a resource manager 106. These components may be coupled together using one or more networks, such as a local area network, or wide area network. In addition, these components may communicate with each other using known protocols, such as the transport control protocol and internet protocol (“TCP/IP”) and hypertext transport protocol (“HTTP”).

The components of content management system 100 may be implemented on separate devices or may be implemented on one or more of the same devices or systems. For example, library server 102 and resource manager 104 may be installed on the same machine and run under a common operating system. Alternatively, content management system 100 may have one or more of its components implemented on multiple machines that run different operating systems. Some of the specific components of content management system 100 will now be described.

Client 102 provides a user interface for content management system 100. Client 102 may be implemented using a variety of devices and software. For example client 102 may be implemented on a personal computer, workstation, or terminal. In addition, client 102 may run under a Windows® operating system, or through a browser application, such as Internet Explorer™ by Microsoft® Corporation or Netscape Navigator™ by Netscape Communications® Corporation. Although FIG. 1 shows a single client, content management system 100 may include any number of clients.

Library server 104 stores, manages, and provides access control to items stored by content management system 100. Library server 104 processes requests, such as creates, reads, updates, and deletes, from client 102 and maintains the data integrity between the other components of content management system 100, such as resource manager 106. For example, library server 104 may work in conjunction with resource manager 106 to retrieve an object, such as a document or image file, that is referenced by an item.

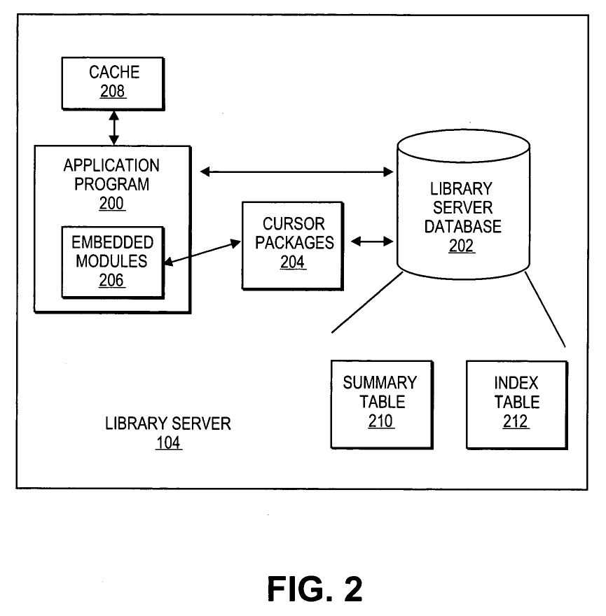

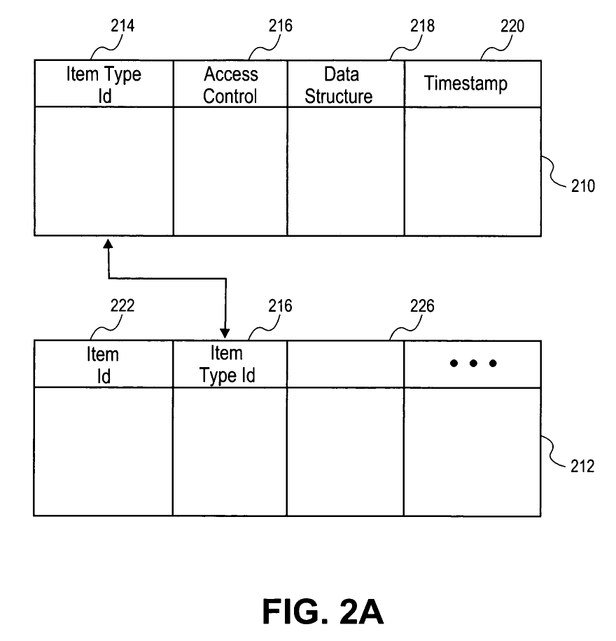

Library server 104 may be implemented using a variety of devices and software. For example, library server 104 may be a computer that runs one or more application programs and stored procedures under an operating system, such as Z/OS®, Windows®, AIX®, or Solaris®. In addition, library server 104 may include a database management system, such as a relational database management system, to manage stored items and perform searches for content management system 100. For example, library server 104 may use the DB2® Universal Database™ by International Business Machines Corporation (IBM®). Library server 104 is also described with reference to FIG. 2.

Resource manager 106 stores objects corresponding to items in content management system 100. Objects may be any data entity for an item that is in digital form. For example, an object may be an audio file, an application, an image, text, or a video file. Resource manager 106 may store the objects in various formats, such as JPEG images, MP3 audio, AVI video, and ASCII text. Resource manager 106 may also store objects in formats, such as Microsoft® Word, Lotus® Word Pro®, and Wordperfect®.

Furthermore, resource manager 106 may also be configured to store multiple copies of objects on the same or a separate resource manager (not shown). Although FIG. 1 shows a single resource manager, content management system 100 may include any number of resource managers. For example, content management system 100 may include multiple resource managers that are distributed across one or networks.

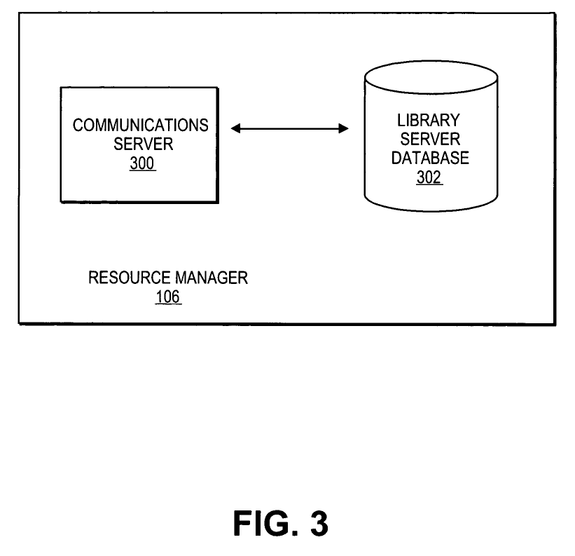

Resource manager 106 may be implemented using known devices and software. For example, resource manager 106 may be installed on one or more computers that run under the z/OS® operating system, and includes a DB2® Universal Database™, as well as a server to communicate with client 102 and library server 104, such as a HTTP server. In addition, resource manager 106 may include one or more storage devices, such as a magnetic disc drive. Resource manager 106 is also described with reference to FIG. 3.

FIG. 2 shows a conceptual diagram of library server 104 that is consistent with the principles of the present invention. As shown, library server 104 may comprise an application program 200, a library server database 202, a set of cursor packages 204, a set of embedded modules 206, and a cache 208.

Application program 200 is program code that implements the functions and procedures and library server 104, such as communications with client 102 and resource manager 106 and operations with library server database 202. Application program 200 may be written in a variety of host programming languages, such as C, C++, Java, or COBOL.

In addition, as shown, application program 200 may include a set of embedded modules 206. For example, embedded modules 206 may include dynamic SQL statements that process requests from client 102. Upon receiving a request from client 102, application program 200 may analyze the request and interact with library server database 202 based on one or more calls to the SQL statements in embedded modules 206.

Library server database 202 serves as a catalog for items stored by content management system 100. In order to catalog a variety items, library server database 202 may classify items according to an item type. An item type may serve as a template for consistently defining and locating like items. Item types may be predetermined by content management system 100 or custom built by a user. Library server database 202 may then create and store items as specific instances of item types. Objects associated with a particular item, such as a document, may then be indexed by library server database 202 and stored by resource manager 106. For example, for an insurance business, library server database 202 may use an item type for insurance claims and policy holders. The item type specifies the format of the information, such as the policy holder name, address, and vehicle information. Each individual claim and policy holder would then be considered an item and indexed by library server database 202. Documents corresponding to each individual claim, such as a fax, may then be stored as objects in resource manager 106.

Library server database 202 may be implemented using a variety of devices and software. For example, library server database 202 may be implemented as a relational database, such as a DB2® Universal Database™. In addition, library server database 202 may use a variety of types of storage, such as tape drive, optical storage units, or magnetic disk drive.

Library server database 202 may use a set of tables, such as a summary table 210 and an index table 212. Summary table 210 may contain information about the attributes and properties of each type of item stored in content management system 100. Index table 212 may contain information that indexes the items stored by content management system 100. For example, index table 212 may index or reference objects stored by resource manager 106 for a particular item. One example of summary table 210 and index table 212 is further described with reference to FIG. 2A.

Cursor packages 204 serve as an interface between application program 200, embedded modules 206, and library server database 202. Cursor packages 204 may be useful because application program 200 may call one or more dynamic SQL statements in embedded modules 206 to retrieve data from library server database 202. Library server database 20 may then return data in the form of sets, e.g., one or more rows from a table, in response to the SQL statements in embedded modules 206. However, application program 200 may use an application programming language that is normally not equipped to deal with data returned in sets. In order to pass data between embedded modules 206 and other components in application program 200, application program 200 may therefore use one or more cursors in cursor packages 204.

A cursor in cursor packages 204 holds a full result set from library server database 202, but allows application program 200 to call one row of information at a time and pass this data to embedded modules 206. For example, application program 200 may pass the data pointed by the cursor into host variables declared within embedded modules 206 that have been linked to the cursor. Once data has been passed to the host variable, application program 200 may then fully use the data with its own programming language, or pass it to another set of embedded SQL statements or to other components of application program 200.

In addition, since application program 200 may use embedded SQL statements in modules 206 that are constructed dynamically, the number of cursors required may vary. Accordingly, application program 200 may open/declare a predetermined number of cursors in cursor packages 204.

Alternatively, application program 200 may progressively open cursors in cursor packages 204 for dynamic SQL statements as they are needed. For example, cursor packages 204 may be divided into several bind files. Application program 200 may initially link into one or more of these bind files to use cursors in cursor packages 204. However, as application program 200 requires more cursors, application program 200 may progressively link into additional bind files. In addition, the number of cursors in each bind file may include different numbers of cursors. For example, the bind files of cursor packages 204 may include a range from a relatively small number of cursors, such as 16 cursors, to a larger number of cursors, such as 1024 cursors. This range in the number of cursors in each bind file may be useful because starting with a small number of cursors may preserve processing resources. However, as more cursors are required by application program 200, cursor packages 204 may provide a progressively larger pool of cursors when needed.

In one embodiment, cursor packages 204 may have two “small” sets of 16 cursors, two “medium” sets of 512 cursors, and two “large” sets of 1024 cursors. The small and medium sets may be linked directly with host variables in embedded modules 206. The large sets of cursors may then be built into a separate library that is called by application program 200 when needed, i.e., when application program 200 has exhausted all of the cursors in the small and medium sets.

Library server 204 may also include a cache 208 to improve its performance. Cache 208 may provide a temporary storage location for information that is frequently used by library server 104 and/or application program 200. For example, application program 200 may store information from library server database 202, such as information from summary table 210 or index table 212, in cache 210. Cache 210 may be implemented using memory installed within library server 204, such as a random access memory. The size of cache 210 may be configured by library server 104 based on user preference and operating conditions.

Referring now to FIG. 2A, examples of summary table 210 and index table 212 are shown. In particular, summary table 210 may comprise an item type identifier column 214, an access control column 216, a data structure column 218, and a timestamp column 220. In addition, for purposes of illustration, FIG. 2A shows one row of sample data for each of these columns.

Item type identifier column 214 includes information that uniquely identifies each type of item managed by content management system 100. An item type identifier may be in a variety of formats, such as numeric or alpha numeric. In addition, the item type identifier may be assigned automatically by library server database 202.

Access control column 216 provides information indicating the types of access controls enforced for each item stored by content management system 100. For example, access control column 216 may include information indicating privileges required to access information in library server database 202 or objects stored in resource manager 106 based on a user's identity or role.

Data structure column 218 contains information about the attributes, such as references, unique attributes, input parameters, output parameters, of each type of item. In addition, data structure column 218 may include a portion of a SQL statement, such as an “INSERT” statement. The information in data structure column 218 may be formatted to assist in the preparation of a dynamic SQL statement. For example, information in data structure column 218 may be a variable length character string that is formatted as a SQL descriptor area data structure. A SQL descriptor area data structure is a group of variables that combine the data of one row of data with metadata items into one data structure. Generally, an SQL descriptor area data structure comprises a header and one or more descriptor areas. The header may contain information describing the entire descriptor. The descriptor areas are variables that describe a parameter marker for a SQL statement, such as the type, length, and pointers for determining the parameters of the SQL statement. In one embodiment, data structure column 218 may use the data structure format of the DB2® SQL descriptor area.

Timestamp column 220 includes information indicating a time for each type of item in summary table 210. For example, timestamp column 220 may include a timestamp indicating the last time one or more attributes of an item type were changed.

Index table 212 indexes the items stored by content management system 100. For example, index table 212 allows library server 104 to locate one or more objects stored in resource manager 106, which correspond to a particular item. As shown, index table 212 may comprise an item identifier column 222, an item type identifier column 224, and one or more value columns 226.

Item identifier column 222 includes information that uniquely identifies each item. An item identifier may be a numeric or alphanumeric sequence that is automatically assigned by library server database 202.

Item type identifier column 224 includes information that indicates an item's type. Library server database 202 may automatically assign an item's type identifier when creating the item. As shown, item type identifier column 224 also corresponds to item type identifier column 214 of summary table 210.

Value columns 226 include information that indicates various attributes of an item. The information in value columns 226 may, for example, include information that describes certain characteristics or properties of an item, such as a first name, surname, age, or city. The information in value columns 226 may also be used as key fields. For example, information in value columns 226 may be used to reference or location objects that are stored in resource manager 106. Value columns 226 may include information in any format, such as numeric, and alphanumeric characters.

FIG. 3 shows a conceptual diagram of resource manager 106 that is consistent with the principles of the present invention. As shown, resource manager 106 may comprise a communication server 300 and a content database 302.

Server 300 provides communication services between resource manager 106, client 102 and library server 104. In one embodiment, communication server 300 is implemented as an HTTP server that is configured to communicate with client 102 and library server 104.

Content database 302 manages and stores objects for content management system 100. Content database 302 may be implemented using a variety devices and software. For example, in one embodiment content database 302 implemented as a relational database, such as DB2® Universal Database™. In addition, content database 302 may use a variety of types of storage, such as can drive optical storage units, or magnetic disk drive.

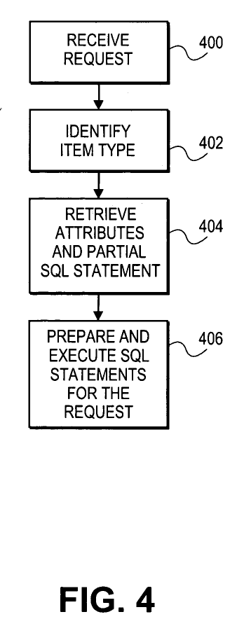

FIG. 4 shows a flow diagram for dynamically constructing SQL statements in accordance with the principles of the present invention. In stage 400, content management system 100 receives a request from a user. For example, a user may operate client 102 to create, read, update, or delete an item or item type, using a browser application or filling out an online form. Client 102 may then gather this information and forward the request to library server 104.

In stage 402, content management system 100 routes the request to library server 104. Library server 104 may then parse the request's contents to identify the item and/or item type affected by the request. For example, library server 104 may run application program 200 to identify an item affected by the request. Application program 200 may then use one or more SQL statements in embedded modules 206 to query library server database 202. In response, library server database 202 may search index table 212 and provide the item's type back to application program 200 based on information in item type identifier column 224.

In stage 404, content management system 100 then retrieves a set of attributes and a partial SQL statement to process the request. In particular, based on an item's type, application program 200 may again call SQL statements in embedded modules 206 to retrieve information from summary table 210.

For example, application program 200 may call SQL statements in embedded modules 206 to directly query library server database 202. In response, library server database 202 may then provide the set of attributes and a partial SQL statement back to application program 200 based the item's type identifier. In particular, library server database 202 may return information from data structure column 218.

Alternatively, application program 200 may indirectly retrieve information from library server database 202. That is, application program 200 may store information, such as a portion of summary table 210 and index table 212, in cache 208. Upon receiving a request, application program 200 may compare the values in timestamp column 220 that are stored in cache 208 and library server database 202. If the timestamps match, application program 200 may then use the information stored in cache 208 rather than retrieving the information from library server database 202. If the timestamps do not match, application program 200 may, as noted above, directly query library server database 202 and also update the information in cache 208.

In stage 406, content management system 100 processes the request. In particular, application program 200 dynamically prepares the SQL statements necessary to process the request based on the set of attributes and partial SQL statement retrieved from summary table 210. In particular, application program 200 may invoke one or more dynamic SQL statements in embedded modules 206. When invoking these embedded dynamic SQL statements, application program 200 may format the dynamic SQL statement in accordance with the retrieved set of attributes. In addition, application program 200 may construct the dynamic SQL statement based on the partial SQL statement retrieved from summary table 210. Furthermore, in order to support the dynamic SQL statements, application program 200 may bind one or more of cursor packages 204 to pass information into host variables declared in embedded modules 206.

Library server 104 may then execute the dynamic SQL statements in accordance with the request. For example, the dynamic SQL statements may cause library server database 202 to create, read, update, or delete one or more items indexed by index table 212. Library server database 202 may then pass any results through cursor packages 204 to embedded modules 206.

In addition, library server 104 may command resource manager 106 to store, retrieve, update, or delete, one or more objects that correspond to a particular item affected by the request. In particular, library server 104 may send one or more commands to communications server 300 in resource manager 106. Resource manger 106 may then continue with processing the request using content database 302. For example, content database 302 may upload an object from client 102, update an object already stored, or delete an object. When content database 302 is finished, resource manager 106 may then notify library server 104 through communications server 300. Library server 104 may then complete the processing of the request and notify the user at client 102.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of dynamically preparing a structured query language statement, said method comprising:
receiving a request that affects an item;
identifying a respective type of the item;
retrieving a set of attributes and a portion of a structured query language statement based on the type of the item; and
preparing the structured query language statement for the item based on the set of attributes and the portion in response to the request.

2. The method of claim 1, wherein retrieving the set of attributes and the portion comprises retrieving a set of parameters that indicate a data structure for the item.

3. The method of claim 1, wherein retrieving the set of attributes and the portion comprises retrieving a set of references for the structured query language statement.

4. The method of claim 1, wherein retrieving the set of attributes and the portion comprises retrieving at least a portion of an insert statement.

5. The method of claim 1, wherein retrieving the set of attributes and the portion comprises retrieving information that indicates access rights for the structured query language statement.

6. The method of claim 1, wherein retrieving the set of attributes and the portion comprises:
determining a timestamp for the set of attributes and the portion; and
selectively retrieving the set of attributes and the portion from a cache based on the timestamp.

7. The method of claim 1, wherein preparing the structured query language statement comprises opening a first set of cursors for the structured query language statement.

8. The method of claim 7, further comprising opening a second set of cursors when all of the cursors in the first set have been opened.

9. An apparatus for dynamically preparing a structured query language statement, said apparatus comprising:
means for receiving a request that affects an item;
means for identifying a respective type of the item;
means for retrieving a set of attributes and a portion of a structured query language statement based on the type of the item; and
means for preparing the structured query language statement for the item based on the set of attributes and the portion in response to the request.

10. A computer readable medium encoded with program code, said medium comprising:
program code for receiving a request that affects an item;
program code for identifying a respective type of the item;
program code for retrieving a set of attributes and a portion of a structured query language statement based on the type of the item; and
program code for preparing the structured query language statement for the item based on the set of attributes and the portion in response to the request.

11. A system that dynamically prepares a structured query language statement, said device comprising:
a database that stores a plurality of items in a first table and stores information indicating attributes of each type of item in a second table; and
a processor configured by a set of program code to receive a request that affects an item stored in the first table of the database, identify a type of the item based on information in the first table, retrieve attributes for the item from the second table based on the item's type, determine a portion of a structured query language statement based on parsing the attributes, and prepare the structured query language statement for the item based on the retrieved attributes and the portion in response to the request.

12. The system of claim 11, further comprising a cache that stores a copy of at least a portion of the second table.

13. The system of claim 12, wherein the second table includes a timestamp for each row in the second table.

14. The system of claim 13, wherein the processor is configured to selectively retrieve information from the cache or the second table based on the timestamp.

15. The system of claim 11, wherein the set of program code comprises a set of embedded structured query language statements for preparing the structured query language statement for the item.

16. The system of claim 15, further comprising a set of files that include a plurality of cursors for the embedded structured query language statements.

17. The system of claim 16, wherein the set of files comprise a first package of cursors that are opened by the embedded structured query language statements.

18. The system of claim 17, wherein the set of files further comprises a second package of cursors that are opened by the embedded structured query language statements when all of the cursors in the first package have been opened.

19. The system of claim 11, wherein the attributes stored in the second table includes information indicating access rights for each type of item.

20. The system of claim 11, wherein the attributes stored in the second table include a structure query language statement that inserts a new item into the first table.
